(19) United States
(12) Patent Application Publication
(10) Pub. No.: US 2006/0059522 A1
(43) Pub. Date: Mar. 16, 2006

(54) Reserve-recording program guiding system and method

(76) Inventor: Chao-Hsiung Huang, Kaohsiung City (TW)

Correspondence Address: LAW OFFICES OF JOHN CHUPA & ASSOCIATES, P.C., 28535 ORCHARD LAKE ROAD, SUITE 50, FARMINGTON HILLS, MI, 48334, US

(21) Appl. No.: 11/216,941

(22) Filed: Aug. 31, 2005

(30) Foreign Application Priority Data
Sep. 15, 2004 (TW) 093127932

(51) Int. Cl. H04N 5/445; G06F 13/00; G06F 3/00

(52) U.S. Cl. 725/58; 725/61

(57) ABSTRACT

The invention provides a reserve-recording program guiding system and method for providing a subscriber with a program to be recorded. The system includes a reservation server, an ordering server, a streaming server and a storing apparatus. When been recorded, the program is stored in the storing apparatus, which generates a program-guiding information corresponding to the recorded program. The ordering server analyzes match between a request information corresponding to the program to be recorded and the program-guiding information, selectively generates an order information based on the analysis result, and transmits the order information to the receiving/transmitting apparatus. When the subscriber responds the order information via the receiving/transmitting apparatus, the streaming server, operated by the ordering server, transmits a real-time stream of the program stored in the storing apparatus to the receiving/transmitting apparatus.

### BACKGROUND OF THE INVENTION

1. Field of the Invention

The present invention relates to a reserve-recording program guiding system and method, and more in particular, to a reserve-recording program guiding system and method for providing a subscriber with a program to be recorded

2. Description of the Prior Art

In recent years, because of the development of High-speed, Wide-band network and digital image processing, Interactive video services also become more and more popular. Video on demand (VOD) service is a typical example of Interactive video services.

VOD service is a newly invented way of network multimedia communication. It greatly shortens the time for the subscriber downloading the files. For a subscriber, the waiting time was several minutes or even more than ten minutes previously. Now he only needs few seconds to see the content without wasting much money and time to download useless data. Moreover, the subscriber can press the button and see at the same time or turn the program forward and backward. The invention makes it easier to watch Internet media. The VOD service also ensures the media provider's right for not leaving any copies at the subscriber's terminal by transmitting data and broadcasting only.

Taking a typical VOD service as an example, the subscriber chooses programs using remote control at home. This program information is put in the far-end VOD server. The program will be transmitted to the Set-top box at home and broadcasted on TV. The subscriber can choose what program to watch, and make it forward, backward, pause or play.

However, as the above-mentioned technique, when a subscriber wants to choose a program, he can only choose it from the pre-recorded programs. In other words, before the program being broadcasted, the subscriber should wait for the media provider recording the program in an Electronic program guide, EPG. Further, the subscriber can click and watch. If the subscriber wants to record the program by himself, he/she should decide the start time for recording the program. When the time is up, he/she has to record the program manually by recording apparatus, e.g., recorder, DVD recorder, and CD-ROM recorder. It is inconvenient for the subscriber.

Accordingly, this invention mainly provides a reserve-recording program guiding system and method for solving above problems.

### SUMMARY OF THE INVENTION

The destination of this invention is providing a reserve-recording program guiding system and method so that a subscriber can record the program conveniently. It can also reduce the cost on other recording apparatus.

The invention of the reserve-recording program guiding system provides a subscriber a program to be recorded, or the subscriber can transmit a request for recording the program and watch the program when it has been recorded. The reserve-recording program guiding system communicates with the subscriber via a receiving/transmitting apparatus. The reserve-recording program guiding system comprises a reservation server, a storing apparatus, an ordering server and a streaming server.

The reservation server transmits reservation information to receiving/transmitting apparatus and receives request information from it. The reservation information corresponds to the program to be recorded and the request information corresponds to the reservation information. The storing apparatus stores the program when it has been recorded and generates program-guiding information. The program-guiding information corresponds to the program that has been recorded.

The ordering server receives the request information from the reservation server and receives the program-guiding information from the storing apparatus. Then, the ordering server analyzes the matches between the request information and the program-guiding information. On the basis of the result of the matches, the ordering server selectively generates an order information and transmitting to the receiving/transmitting apparatus. When the subscriber responds the order information via receiving/transmitting apparatus, the streaming server is operated by the ordering server then to transmit a real-time stream of the program stored in the storing apparatus to receiving/transmitting apparatus.

With the invention of the reserve-recording program guiding system, the subscriber can reserve a program to be recorded. The system will record the program automatically when it is broadcasted. Further, when the program has been recorded, the system will transmit notice information to the subscriber for deciding whether to watch. Hence, the invention not only increases the convenience recording the program but also reduces the cost on other recording apparatus. These and other objectives of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a function block diagram schematically showing a reserve-recording program guiding system according to the preferred embodiment of the invention and a receive/transmit apparatus.

FIG. 2 is a function block diagram schematically showing the reserve-recording program guiding system of FIG. 1 connecting with a program recording system.

FIG. 3 is a flow chart diagram showing the reserve-recording program guiding method of the invention.

### DETAILED DESCRIPTION OF THE INVENTION

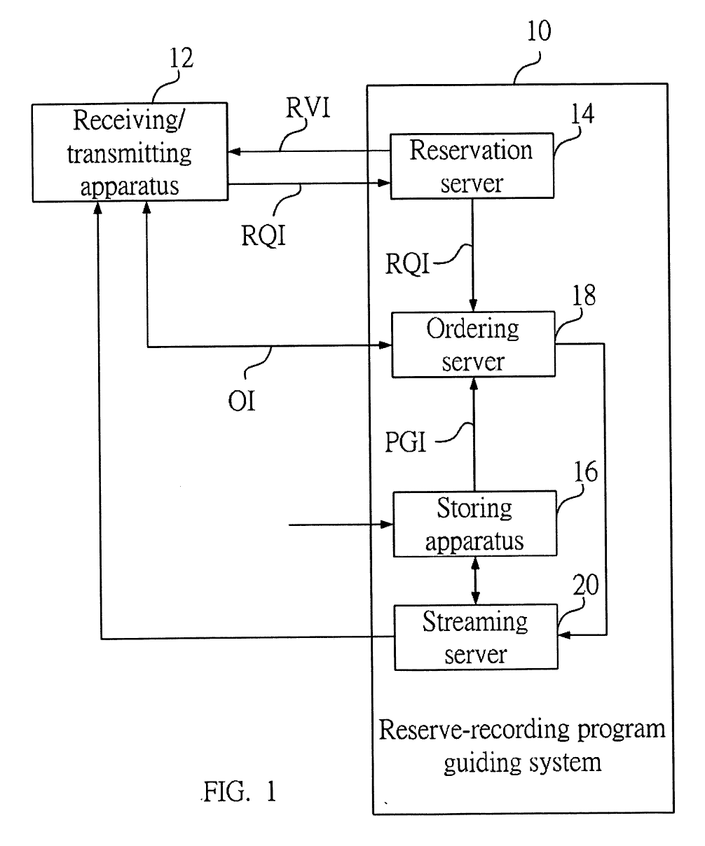

Referring to FIG. 1, FIG. 1 is a function block diagram schematically showing a reserve-recording program guiding system 10 according to a preferred embodiment of the invention and a receiving/transmitting apparatus 12. The reserve-recording program guiding system 10 of the invention communicates with the subscriber via the receiving/transmitting apparatus 12. The receiving/transmitting apparatus 12 can be a computer, a TV combined with set-top boxes, a digital TV, an integrated digital TV with computer built inside, portable DVD player with storage device built inside, or other similar apparatus.

As shown in FIG. 1, the reserve-recording program guiding system 10 includes a reservation server 14, a storing apparatus 16, an ordering server 18 and a streaming server 20.

The reservation server 14 transmits a reservation information RVI, corresponding to the program to be recorded, to the receiving/transmitting apparatus 12, and receives a request information RQI, corresponding to the reservation information RVI, from the receiving/transmitting apparatus 12. The storing apparatus 16 stores the program when the program has been recorded, and generates a program-guiding information PGI corresponding to the program been stored.

The ordering server 18 receives the request information RQI from the reservation server 14 and receives the program-guiding information PGI from the storing apparatus 16. The ordering server 18 functions analyzing match between the request information RQI and the program-guiding information PGI. On the basis of the result of the match between the request information RQI and the program-guiding information PGI, the ordering server 18 selectively generates an ordering information OI, and transmits the order information OI to the receiving/transmitting apparatus 12. The program-guiding information PGI includes an address information of the program been recorded. The ordering information includes a hyperlink of the address information.

For example, the request information RQI includes a title of the program to be recorded. The program-guiding information PGI includes a title of the stored program. The ordering server 18 analyzes the match between the title of the program to be recorded and the title of the stored program. For another example, the request information RQI includes a channel of providing the program to be recorded. The program-guiding information PGI includes a channel of providing the stored program. The ordering server 18 analyzes the match between the channel of providing the program to be recorded and the channel of providing the stored program.

When the subscriber responds the ordering information OI via the receiving/transmitting apparatus 12, the ordering server 18 operates the stream server 20 to transmit a stream stored in the storing apparatus 16 to the receiving/transmitting apparatus 12. The stream server 20 uses a Real time streaming protocol (RTSP) a Real-time transport protocol RTP a Microsoft media server protocol (MMS) or other commutation protocol to transmit the stream to the receiving/transmitting apparatus 12.

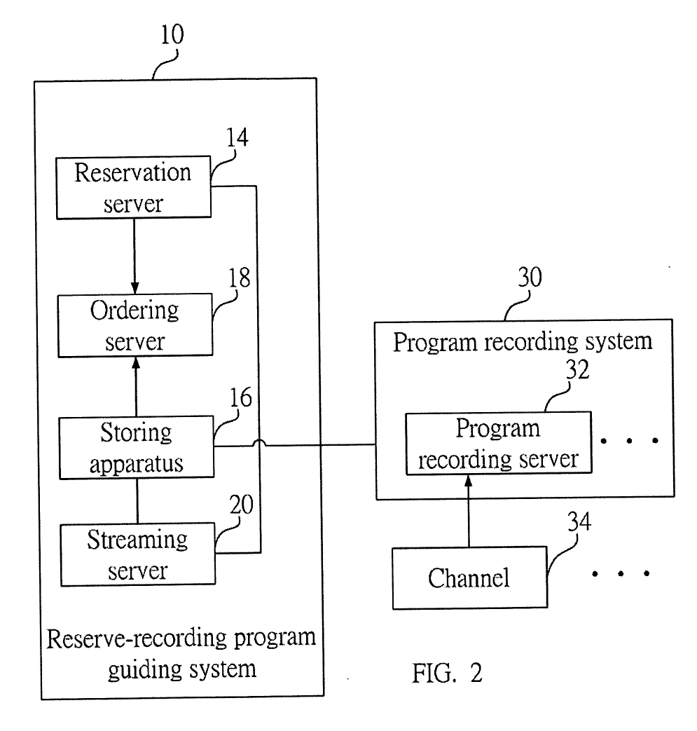

Referring to FIG. 2, FIG. 2 is a schematic diagram showing connection between the reserve-recording program guiding system 10 and a program recording system 30. The program recording system 30 records program and transmits the program been recorded to the reserve-recording program guiding system 10 for the subscriber to watch. The program recording system 30 could include several program-recording servers 32. Each program-recording server functions recording a program of the corresponding channel 34 when it is broadcasting. In other words, the program finishes broadcasting and the program-recording server finishing recording at the same time. Then the program-recording server transmits the recording file to the storing apparatus 16 for the subscriber watching. Every program will be recorded in a corresponding format, such as *.avi, *.mpg, *.wmv, *.mp4, *.mov, *.asf, *.rm, and *.rmvb.

For example, the subscriber can input a request information by a remote control (or other similar apparatus) according to the reservation information RVI and transmits to the reservation server 14 via the receiving/transmitting apparatus 12. The reservation server 14 will further transmits the request information RQI to the ordering server 18. When the programs included in the request information RQI has been broadcasted and recorded by the program recording system 30, the program recording system 30 will transmit the recording file to the storing apparatus 16. The storing apparatus 16 will generate a program-guiding information PGI to the ordering server 18. After that, the ordering server 18 will analyze the matches between the request information RQI and the program-guiding information, PGI and selectively generate an ordering information OI. Furthermore, the ordering server 18 will transmit the ordering information to the receiving/transmitting apparatus 12 to notify the subscriber that the program has been recorded. At the same time, the subscriber can click on the address information of the program has been stored by the remote control (or other similar apparatus) to watch the program.

Using the invention of the reserve-recording program guiding system 10, when the subscriber wants to pre-record a program, he only has to input a request information through an operation apparatus. When the program has been recorded, he can watch it immediately. Therefore, by using the invention of the reserve-recording program guiding system 10, the subscriber not only avoids complicated operation procedure but also not needs additional storing apparatus when recording and watching the program. Furthermore, it can increase the convenience pre-recording the program and reduce the cost on other storing apparatus.

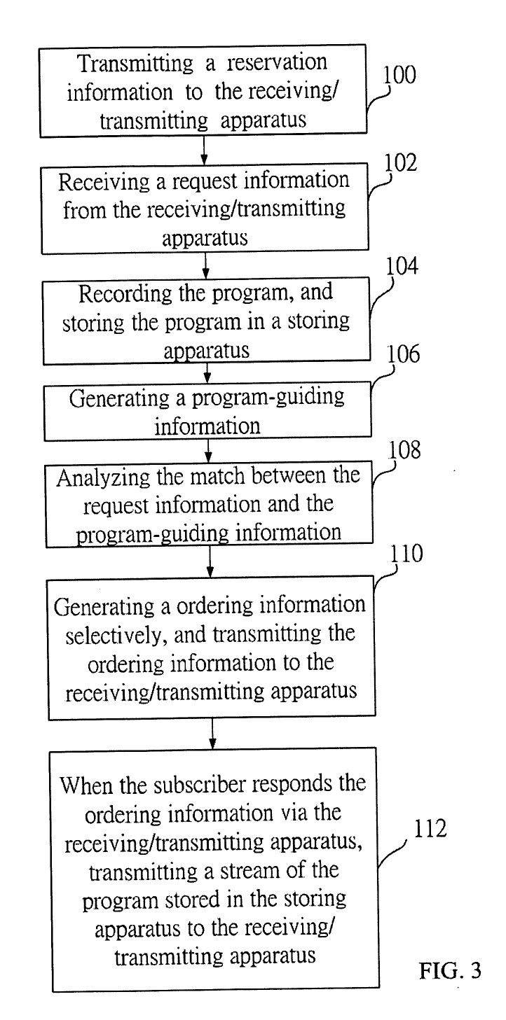

Referring to FIG. 3, FIG. 3 is a flow chart showing the reserve-recording program guiding method according to a preferred embodiment of the invention. The subscriber has a receiving/transmitting apparatus 12 as shown in FIG. 1. The following uses the recording program guiding system 10 of FIG. 1 to show the recording program guiding method. According to the invention, the recording program guiding method includes the steps of:
100: transmitting a reservation information RVI corresponding to the program to be recorded to the receiving/transmitting 12;
102: receiving a request information RQI corresponding to the reservation information RVI from the receiving/transmitting apparatus 12;
104: recording the program and storing the program in the storing apparatus 16;
106: generating a program-guiding information PGI corresponding to the program to be recorded;
108: analyzing the matches between the request information RQI and the program-guidirig information PGI;
110: on the basis of the step 108, selectively generating an ordering information OI, and transmitting the ordering information OI to the receiving/transmitting 12; and
112: when the subscriber responds the ordering information OI via the receiving/transmitting 12, transmitting a stream of the program stored in the storing apparatus 16 to the receiving/transmitting 12.

Compared to the conventional techniques, the subscriber can reserve a program by using the invention of the reserve-recording program guiding system 10. When the program is broadcasted, the system will record the program automatically. Moreover, when the program has been recorded, the system will further transmit a notice information to the subscriber to decide whether to watch. Hence, the invention not only greatly increases the convenience recording the program but also reduce the cost on the other recording apparatus. With the invention, it is noted that the receiving/transmitting apparatus can be equipped without a storage device for storing the program that the subscriber wants to watch, i.e., the manufacture of the receiving/transmitting apparatus can be cost down.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A reserve-recording program guiding system for providing a subscriber with a program to be recorded, said system communicating with the subscriber via a receiving/transmitting apparatus, said system comprising:
a reservation server, for transmitting a reserved information, corresponding to the program to be recorded, to and receiving a request information responsive to the reservation information from the receiving/transmitting apparatus;
a storing apparatus, for storing the program when the program has been recorded, and generating a program-guiding information corresponding to the stored program;
an ordering server, for receiving the request information from the reservation server, analyzing match between the request information and the program-guiding information while receiving the program-guiding information from the storing apparatus, generating an order information selectively on the basis of the result of analyzing between the request information and the program-guiding information, and transmitting said order information to the receiving/transmitting apparatus; and
a streaming server, when the subscriber responds the order information via the receiving/transmitting apparatus, said streaming server is operated by the ordering server to transmit a stream of the program stored in the storing apparatus to the receiving/transmitting apparatus.

2. The system of claim 1, wherein the request information comprises a title of the program to be recorded, the program-guiding information comprises a title of the stored program, the ordering server analyzes if the title of the program to be recorded matches the title of the stored program.

3. The system of claim 2, wherein the request information comprises a channel of providing the program to be recorded, the program-guiding information comprises a channel of providing the stored program, and the ordering server analyzes if the channel of providing the program to be recorded matches the channel of providing the stored program.

4. The system of claim 1, wherein the program-guiding information comprises an address information of the stored program, the ordering information comprises a hyperlink of said address information.

5. The system of claim 1, wherein the streaming server transmits the stream of the program to the receiving/transmitting apparatus with a real time streaming protocol (RTSP) a real-time transport protocol (RTP) or a Microsoft media server protocol (MMS).

6. A reserve-recording program guiding method, for providing a subscriber with a program to be recorded, said subscriber holding a receiving/transmitting apparatus, said method comprising the steps of:
(a) transmitting a reservation information, corresponding to the program to be recorded, to the receiving/transmitting apparatus;
(b) receiving a request information responsive to the reservation information from the receiving/transmitting apparatus;
(c) when the program has been recorded, storing the program been recorded;
(d) generating a program-guiding information corresponding to the stored program;
(e) analyzing match between the request information and the program-guiding information;
(f) based on the result of step (e), selectively generating an order information, and transmitting the order information to the receiving/transmitting apparatus; and
(g) when the subscriber responds the order information via the receiving/transmitting apparatus, transmitting a stream of the stored program to the receiving/transmitting apparatus.

7. The method of claim 6, wherein the request information comprises a title of the program to be recorded, the program-guiding information comprises a title of the stored program, step (e) is to analyze the match between the title of the program to be recorded and the title of the stored program.

8. The method of claim 7, wherein the request information comprises a channel of providing the program to be recorded, the program-guiding information comprises a channel of providing the stored program, and step (e) is to analyze the match between the channel of providing the program to be recorded and the channel of providing the stored program.

9. The method of claim 6, wherein the program-guiding information comprises an address information of the stored program, and the order information comprises a hyperlink of the address information.

10. The method of claim 6, wherein in step (g), the stream of the program is transmitted to the receiving/transmitting apparatus by a real time streaming protocol, a real-time transport protocol (RTP) or a Microsoft media server protocol (MMS).
